(19) United States
(12) Patent Application Publication
(10) Pub. No.: US 2021/0391601 A1
(43) Pub. Date: Dec. 16, 2021

(54) BATTERY TEST ASSEMBLY

(71) Applicant: BAE Systems Controls Inc., Endicott, NY (US)

(72) Inventor: William J. Doak, Apalachin, NY (US)

(73) Assignee: BAE Systems Controls Inc., Endicott, NY (US)

(21) Appl. No.: 16/898,790

(22) Filed: Jun. 11, 2020

(51) Int. Cl. H01M 10/42; H01M 2/16; H01M 10/6571; H01M 10/48; H01M 10/613

(52) U.S. Cl. CPC H01M 10/425; H01M 2/1673; H01M 10/613; H01M 10/486; H01M 10/6571

(57) ABSTRACT

The present disclosure includes a battery test assembly. The battery test assembly includes a container forming an enclosed cavity having sides, a top and a bottom with an opening in the top, a first electrode having a first non-electrically active coating material, a second electrode having a second non-electrically active coating material, a separator disposed between the first electrode and the second electrode the separator including an insulator material and a non-ionic liquid within the cavity, wherein the first electrode, separator and second electrode are wound in a spiral configuration within the container.

### BACKGROUND

One issue with lithium-ion battery technology is thermal safety. A primary safety concern when using, handling, and transporting lithium-ion batteries is thermal runaway. This is a phenomenon wherein a series of self-sustaining exothermic side-reactions lead to total failure of the cell and, in some cases, fire and/or explosion. Most lithium-ion batteries have the potential to experience thermal runaway due to the chemical nature of current lithium-ion technology. While significant attention has been paid to cell performance over time (capacity fade, available power, etc.) there is little data about how a cell failure, in particular thermal runaway profiles, may change over time.

Further, thermal management of lithium-ion cells, such as cylindrical cells, is important for maintaining battery life, performance, safe operation, as well as minimizing the chance of a thermal runaway event. However, it has been a challenge to accurately know or predict, through modeling or measurement, the internal temperature of the cell and the effect of various cooling methods used to manage the cell temperature.

Typically, a lithium-ion cell, such as a cylindrical cell, is constructed of: a can, which provides the primary structure to the cell and serves as the negative electrode (typically aluminum or steel; a jelly-roll, which is the electrical energy storage component comprised of wound current collector sheets (typically copper and aluminum foil coated with active material) separated by a porous membrane (typically, polymer or ceramic); an electrolyte that fills the can and permeates the active material on the current collectors and in the porous membrane; and a cap, which is the positive electrode, that is crimped in place on the top of the can thus enclosing the jelly-roll and forming a completed cell.

The nature of the cell construction makes it nearly impossible to measure the temperature at various locations internal to the cell, or to measure heat transfer through the cell during operation. It is likewise difficult to measure these quantities during a thermal runaway event.

This inability to measure the internal thermal characteristics of the cell poses a challenge when attempting to quantify and compare the effects of cooling the cell through its sidewall (using submersion or flow cooling) and cooling through the ends (cooling the bus bars with a cold plate). Furthermore, it inhibits proper understanding and interpretation of data gathered during an induced thermal runaway event; a necessary safety test that must be conducted prior to commercializing a product utilizing a lithium-ion battery.

### SUMMARY

The present disclosure includes a battery test assembly. The battery test assembly includes a container forming an enclosed cavity having sides, a top and a bottom with an opening in the top, a first electrode having a first non-electrically active coating material, a second electrode having a second non-electrically active coating material, a separator disposed between the first electrode and the second electrode the separator including an insulator material and a non-ionic liquid within the cavity, wherein the first electrode, separator and second electrode are wound in a spiral configuration within the container.

### BRIEF DESCRIPTION OF THE DRAWINGS

The drawings are provided for illustrative purpose only and do not necessarily represent practical examples of the present invention to scale. In the figures, the same reference signs are used to denote the same or like parts.

FIG. 1 is a vertical cross sectional view of a battery test assembly.

FIG. 2 is a horizontal cross sectional view of a battery test assembly.

FIG. 3 is a flow chart illustrating a method of testing the battery test assembly.

### DETAILED DESCRIPTION

In the discussion and claims herein, the term “about” indicates that the value listed may be somewhat altered, as long as the alteration does not result in nonconformance of the process or device. For example, for some elements the term “about” can refer to a variation of ±0.1%, for other elements, the term “about” can refer to a variation of ±1% or ±10%, or any point therein.

As used herein, terms defined in the singular are intended to include those terms defined in the plural and vice versa.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat.

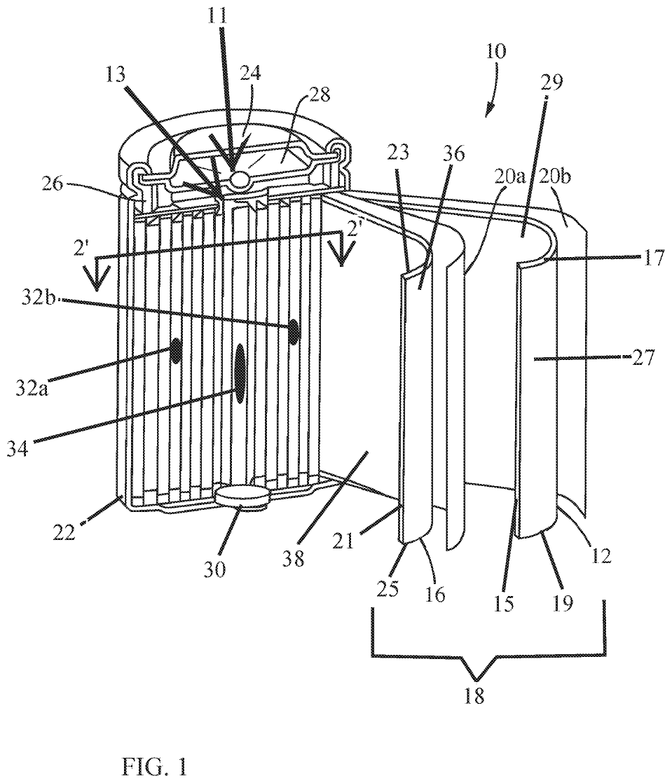

Referring to FIG. 1, a vertical cross sectional view of an electrode assembly 10 is shown, which can be used as a battery test assembly. As can be seen in FIG. 1, the electrode assembly 10 includes a container 22, wherein the container 22 forms an enclosed cavity 11 (although cavity is shown as full of material, discussed in further detail below, in this view) with an opening 13 in the top of the container. In some embodiments, the side wall and bottom of the container 22 can be configured to be a negative terminal of the electrode assembly 10. Also, the container 22 can be in any suitable shape, such as in a cube shape, a cuboid shape, a spherical shape, a conical shape, an ellipsoid shape, or a cylindrical shape as shown in the figures.

The container 22 can be an element specifically designed to operate as a test cell, or container 22 can be a container of an existing battery, which has had at least some of the internal material removed. In some embodiments, all material within a typical battery container can be removed, or only a liquid can be removed so that the internal electrodes remain. Under the first embodiment, the typical container can then have components discussed below added to it. Under the second embodiment, the typical container, including the typical electrodes within it, can have the below described liquid, as well as the below described sensors added to it.

Within the container 22 is a first electrode 12 comprising a first electrode material, the first electrode 12 comprising a first electrode leading edge 15 and a first electrode trailing edge (not shown), and also a first electrode upper edge 17 and a first electrode lower edge 19, the first electrode upper edge 17 being opposite the first electrode lower edge 19. The first electrode upper edge 17 is also closer to the opening 13 than the first electrode lower edge 19. The first electrode 12 can also include a first electrode first surface 27 and a first electrode second surface 29, the first electrode second surface 29 opposite the first electrode first surface 27.

The first electrode 12 material may comprise aluminum (Al), lithium (Li), sodium (Na), potassium (K), calcium (Ca), magnesium (Mg), including alloys for these elements, carbon or graphite material capable of intercalation (such as lithiated carbon, Li_{X}Ti₅O₁₂) silicon (Si), tin (Sn), and combinations thereof of any of these materials.

Also within the container 22 is a second electrode 16 comprising a second electrode material, the second electrode 16 comprising a second electrode leading edge 21 and a second electrode trailing edge (not shown), and also a second electrode upper edge 23 and a second electrode lower edge 25, the second electrode upper edge 23 opposite the second electrode lower edge 25. The second electrode upper edge 23 is also closer to the opening 13 than the second electrode lower edge 25. The second electrode 16 can also include a second electrode first surface 36 and a second electrode second surface 38, the second electrode second surface 38 opposite the second electrode first surface 36.

The second electrode 16 material may comprise, in one embodiment, a fluorinated carbon represented by the formula (CFₓ)ₙ wherein x varies between about 0.5 and about 1.2, and (C₂F)ₙ (the subscript n in both examples refers to the number of monomer units and may vary widely). In other embodiments, the second electrode 16 may comprise, copper sulfide (CuS), copper oxide (CuO), lead dioxide (PbO₂), iron sulfide (FeS), iron disulfide (FeS₂), pyrite, copper chloride (CuCl₂), silver chloride (AgCl), silver oxide (AgO, Ag₂O), sulfur (S), bismuth oxide (Bi₂O₃), copper bismuth oxide (CuBi₂O₄), cobalt oxides, vanadium oxide (V₂O₅), tungsten trioxide (WO₃), molybdenum trioxide (MoO₃), molybdenum disulfide (MoS₂), titanium disulfide (TiS₂), transition metal polysulfides, lithiated metal oxides and sulfides, such as lithiated cobalt and/or nickel oxides, lithiated manganese oxides, LiₓTiS₂, LiₓFeS₂, LiFePO₄, LiFeNbPO₄, and mixtures of any of the foregoing materials.

The first electrode 12 material may be an anode electrode material and the second electrode 16 material may be cathode electrode material. Alternatively, the first electrode 12 material may be cathode electrode material and the second electrode 16 material may be anode electrode material.

Disposed between the first electrode 12 and the second electrode 16 is a separator 20 (shown in FIG. 1 as 20a, and 20b). The separator 20 may comprise one or more materials, such as an insulating material, an impermeable material, a substantially impermeable material or a microporous material, the material selected from one or more of polypropylene, polyethylene, and combinations thereof. The material may include filler, such as oxides of aluminum, silicon, titanium, and combinations thereof. The separator 20 may also be produced from microfibers, such as by melt blown nonwoven film technology. The separator 20 may have a thickness from about 8 to about 30 micrometers (microns), or thicker. The separator 20 may also have little or no pores, or include pores having a pore size range from about 0.005 to about 5 microns, or a pore size range from about 0.005 to about 0.3 microns. The separator 20 may have little or no porosity, or have a porosity range from about 30 to about 70 percent, preferably from about 35 to about 65 percent.

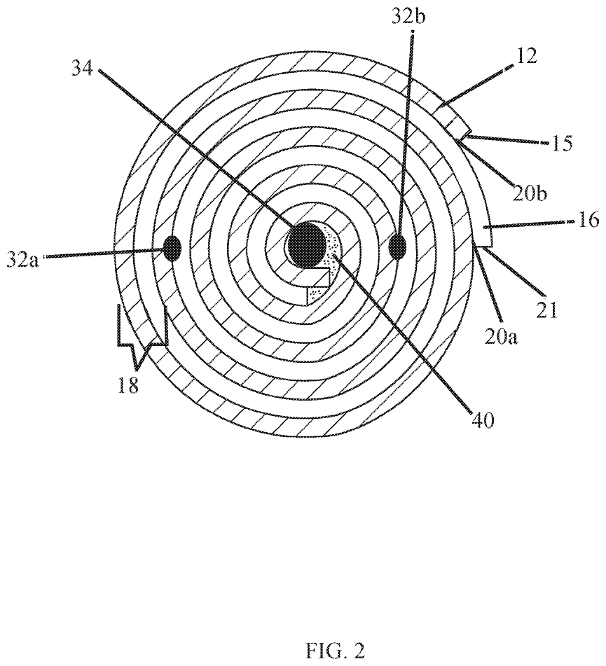

The first electrode 12 and the second electrode 16, with separator 20 disposed therebetween, may be wound into a spiral-wound electrode assembly, also referred to as a jelly-roll electrode assembly (“jelly-roll”), or a spiral wound first electrode 12, second electrode 16 and separator 20 that forms a layer 18. This layer 18 repeats throughout the interior of the container 22, as shown in FIG. 1, which is a vertical cross sectional view of the electrode assembly 10. This layer 18 is also shown in the horizontal cross sectional view of the electrode assembly 10 of FIG. 2, which is taken at line 2′-2′ of FIG. 1.

Also within the container 22, in void spaces not filled with the other elements in the container (such as the first electrode 12, the second electrode 16 and the separator 20) is a liquid 40 (shown in the voids of FIG. 2, but the liquid 40 would be throughout the interior of the container 22, contacting surfaces of the first electrode 12, the second electrode 16 and the separator 20). The liquid 40 can be any suitable liquid that is not an electrolyte in that it does not allow the typical battery chemical reaction to create electrical activity to charge a battery, but has other qualities that are at least partially analogous to an electrolyte. Some examples of this liquid is a liquid that is non-ionic or substantially non-ionic, and this liquid does not include a salt component, a liquid that is not a solvent, a liquid that has little or no reactivity with any of the first electrode 12, the second electrode and the separator 20. Other specific examples of this liquid are alcohols, propylene carbonate, dimethyl carbonate, ethylene carbonate, diethyl carbonate, ethyl methyl carbonate, and combinations thereof. During formation of the electrode assembly 10, all surfaces of the first electrode 12, the second electrode 16 and the separator 20 can have the liquid 40 applied to them. As an example of this application, the first electrode 12, the second electrode 16 and the separator 20 can be “wet-rolled” by submerging them, or dipping them in fluid 40, and then winding them into the structure shown in FIG. 2.

The liquid 40 is included within the container 22 to act substantially as an electrolyte of a battery, such a lithium ion battery, but have minimal or none of the hazardous qualities or electrical activity that typical electrolytes possess. One such typical electrolyte is the soluble form of lithium hexafluorophosphate (LiPF₆). Thus, the liquid 40 within the container 22 can be any suitable liquid having at least one of a boiling point and a vapor pressure that is within about 5% to about 30% of a boiling point and a vapor pressure of LiPF₆, or within about 20% of a boiling point and a vapor pressure of LiPF₆, or within about 10% of a boiling point and a vapor pressure of LiPF₆, or within about 5% of a boiling point and a vapor pressure of LiPF₆.

Also included in the container 22 is a pressure sensor 30. The pressure sensor 30 can be located in any suitable location within the container, such as is between the first electrode second edge 19 and the container 22, as illustrated in FIG. 1 (however no lead wires from the pressure sensor 30 are shown for ease of illustration). The pressure sensor 30 can be any suitable sensor that can detect changes in pressure, such as, for example, a piezoresistive differential pressure sensor (operating on strain gauge technology), a capacitance-based differential pressure sensor (in which the capacitance of the pressure sensor 30 changes as a function of the pressure drop), or any other suitable pressure sensor.

The pressure sensor 30 can be capable of operation at high pressures (>2000 Pa) and/or high temperatures (>300° C.). However, the pressure sensor 30 is not limited to operating at high temperatures, and is also suitable for operation at temperatures between about 25° C. to about 300° C., or lower temperatures. In some embodiments, for example, the pressure sensor 30 may be utilized at temperatures down to about 0° C., and in some embodiments.

The pressure sensor 30 can measure pressures within the sealed electrode assembly 10 at any time, such as when heat is applied to, or generated by, the electrode assembly 10. The pressure sensor 30 can measure pressures within the sealed electrode assembly 10 during application of electrical energy to the electrode assembly 10 or during withdrawal of electrical energy from the electrode assembly 10. The output from the pressure sensor 30 in one example is via the lead wires (not shown), in other examples, the pressure sensor 30 can output data wirelessly, such as through a wireless internet connection, a Bluetooth connection, a Near Field Communication connection, etc.

Optionally, the container 22 can also include a thermocouple 32. For example, two thermocouples 32a and 32b are shown in FIG. 1 between wound portions of the first electrode 12 and the second electrode 16 (however no lead wires from the thermocouple 32 are shown for ease of illustration). In other examples, the thermocouple 32 could be in the center of the wound first electrode 12 and the second electrode 16, and/or the thermocouple 32 could be between the first electrode first surface 27 and the container 22. In other examples, three or more thermocouples 32 can be included in the container 22 at various locations, so that a temperature gradient can be measured.

The location of the thermocouple 32 is shown as one example in FIG. 1, however, in other embodiments two, three or more thermocouples may be within container 22, and may be placed anywhere along the vertical cross section and horizontal cross section of the electrode assembly 10.

The thermocouple 32 is any temperature-measurement device, and refers without limitation to a device including two different conductors (such as, for example metal alloys) that produce a voltage, proportional to a temperature difference, between either ends of the two conductors. A thermocouple of this type may be referred to as a contact-type sensor, but that term as used herein may include thermocouples that are positioned close to, but not actually contacting the article to be sensed. The output from the thermocouple 32 in one example is reported via lead wires (not shown)), in other examples, the thermocouple 32 can output data wirelessly, such as through a wireless internet connection, a Bluetooth connection, a Near Field Communication connection, etc.

Optionally, the container 22 can also include a heater 34. For example a heater 34 is shown in FIG. 1 (although no electrical leads from the heater 34 are included, for ease of illustration), as a resistive insertion heater, in the center of the wound first electrode 12 and the second electrode 16. The location of the heater 34 is shown as one example in FIGS. 1 and 2, however, in other embodiments two, three or more heaters may be within container 22, and may be placed anywhere along the vertical cross section and horizontal cross section of the electrode assembly 10.

In another embodiment, the heater 34 could be in the shape of a sheet (not shown), as a resistive sheet heater, which could be used to replace the separator 20, or could be wound along at least a portion of the wound first electrode 12 and the second electrode 16, between the first electrode 12 and the separator 20, between the second electrode 16 and the separator 20, or between both the first electrode 12 and the separator 20 and the second electrode 16 and the separator 20.

The heater 34 can be any suitable element that is capable of producing heat upon receipt of an electrical input such as via lead wires (not shown), and can be formed of a substrate composed of a conductive material that is configured to receive an electrical input from outside the electrode assembly 10. The heater 34 can have an electrical resistance useful for providing resistive heating in response to the electrical current applied to the heater 34. For example, in some embodiments, the heater 34 can have an electrical resistance of about 50 ohms or less. In other embodiments the heater 34 can have an electrical resistance of about 25 ohms or less, an in other embodiments he heater 34 can have an electrical resistance of about 10 ohms or less.

Optionally, one or both of the first electrode first surface 27 and the first electrode second surface 29 of the first electrode 12 are coated, partially or wholly, with a first electrode non-electrically active coating material (not shown). The first electrode non-electrically active coating material is any coating suitable of adhering to the first electrode material 12, such as a coating that includes an oxide and/or an inactive anode or inactive cathode material.

Optionally, one or both of the second electrode first surface 36 and the second electrode second surface 38 of the second electrode 16 are coated, partially or wholly, with a second electrode non-electrically active coating material (not shown). The second electrode non-electrically active coating material is any coating suitable of adhering to the second electrode material 16, such as a coating that includes an oxide and/or an inactive anode or inactive cathode material.

The electrode assembly 10 can also include a cap 24 and an optional annular insulating gasket 26 (collectively referred to as an end-cap assembly). The cap 24 is in electrical isolation from the container 22 and can be configured as a positive terminal of the electrode assembly 10. Also, the cap 24 can be configured to attach to the container 22 in any suitable way, thus covering the opening 13 and forming a pressure tight cavity 11 within the container 22. The electrode assembly 10 may also include a suitable safety valve 28. Although not shown, an electrical connector or tab can extend from one of the first electrode 12 and the second electrode 16 to the container 22, thus simulating electrically connecting the first electrode 12 or the second electrode 16 to the container 22. Also not shown, an electrical connector or tab can extend from the one of the first electrode 12 and the second electrode 16 not connected to the container 22 to the cap 24, thus electrically connecting the first electrode 12 or the second electrode 16 to the cap 24. The electrical connectors or tabs can simulate the electrical connection of typical battery cells and can also provide a thermal path for cooling of the electrode assembly 10.

Although the lead wires for the pressure sensor 30, the thermocouple 32 and the heater 34 are not shown in FIG. 1, lead wires from each would extend between the cap 24 and container 22 to connect to various measurement devices and power sources external to the electrode assembly 10. Or, in another embodiment, a separate opening could be made in either or both of the cap 24 and the container 22 for the lead wires for each of the pressure sensor 30, the thermocouple 32 and the heater 34 to pass through to connect to various measurement devices and power sources external to the electrode assembly 10. In this alternate embodiment, the opening could be sealed in a suitable way, after the leads are passed through, so that the pressure tight cavity 11 would remain pressure tight.

FIG. 2, is a horizontal cross sectional view of the electrode assembly 10, with several elements not included for ease of illustration, including the container 22, the cap 24, the gasket 26, and the safety valve 28.

As can be seen in FIG. 2, disposed between the first electrode 12 and the second electrode 16 is the separator 20 (shown in FIG. 2 as 20a, and 20b), and, in this embodiment, is comparatively thinner than the first electrode 12 and the second electrode 16. In this figure, the first electrode 12 and the second electrode 16, with separator 20 disposed therebetween, are wound into a spiral-wound electrode assembly (“jelly-roll”).

From the view of FIG. 2, the first electrode leading edge 15, the second electrode leading edge 21, a thermocouple 32 and the heater 34 are visible. In this embodiment, two thermocouples 32a and 32b are shown in FIG. 2 between wound portions of the first electrode 12 and the second electrode 16. No lead wires from the thermocouples are shown for ease of illustration.

The electrode assembly 10 can be made to be similar mechanically to a typical lithium ion cell, but due to the liquid and components within the electrode assembly not being capable of providing or accepting electrical power. In this embodiment, the container 22, the cap 24, the gasket 26, and the safety valve 28 are all the same as production lithium ion cells.

In this embodiment, the first electrode 12, the second electrode 16, the separator 20 and the liquid provide substantially the same thermal mass as a production lithium ion cell. Also in this embodiment, the first electrode 12 and the second electrode 16 are attached to both the container 22 and the cap 24 in a suitable way, which substantially imitates the thermal path from the “jelly-roll” to the container 22 and the cap 24 as this thermal path would be in a typical lithium ion cell.

In this embodiment, the electrode assembly 10 can be used to substantially simulate the thermal characteristics of a typical lithium ion cell during typical charging and discharging operations. In this embodiment, the electrode assembly 10 substantially simulates the non-uniform heat generation during operation of typical lithium ion cells and substantially provides the anisotropic heat transfer characteristics of typical lithium ion cells.

In addition, in this embodiment, the thermocouple 32 allows for a substantially proper characterization of various sidewall and end cooling methods. The ability to measure the induced internal thermal gradients within the electrode assembly 10 can be used to both optimize a cooling method(s) for typical lithium ion cells and estimate cell cycle life for typical lithium ion cells.

Further, in this method, a test of the electrode assembly 10 can be performed in ‘reverse’ where heat is applied to the outside of the electrode assembly 10 as a simulation of a thermal runaway event. In this test both the internal pressure (monitored by the pressure sensor 30) and the internal temperature (monitored by the thermocouple 32) are recorded. During this simulation of a thermal runaway event, the behavior of the liquid; how much heat does the liquid circulate, how much heat does the liquid absorb during phase change, how much gas does the liquid generates, and what is the liquids state when the safety valve 28 ruptures and the cap 24 ruptures, respectively, can be determined through measurements of the pressure sensor 30 and the thermocouple 32. In this example, and any other embodiment of the disclosure, the container 22 can also include at least one gas sensor and/or at least one imaging sensor to transmit gas component values and/or images from a point inside the container 22.

Thus a first method of using the electrode assembly 10 is to apply electrical energy to heater 43 at various amounts and durations, while measuring the temperature at the location of the thermocouple 32 and while measuring the pressure within the electrode assembly 10 with the pressure sensor. A second method is to apply heat, from an external heat source, to the electrode assembly 10 while measuring the temperature at the location of the thermocouple 32 and while measuring the pressure within the electrode assembly 10 with the pressure sensor. In a third method, both the first method and the second method, are performed at the same time, so that heat is generated from within the electrode assembly 10 and external heat is applied to the electrode assembly.

A fourth method of using the electrode assembly 10 is to apply electrical energy to heater 43 at various amounts and durations, while exposing the electrode assembly 10 to one or more cooling methods, such as a sidewall cooling method (at least one of a submersion cooling and a flow cooling), and a cooling through the ends (such as cooling an end of the electrode assembly 10 with a cold plate). During this fourth method the temperature at the location of the thermocouple 32 and the pressure within the electrode assembly 10 with the pressure sensor can both be measured and recorded.

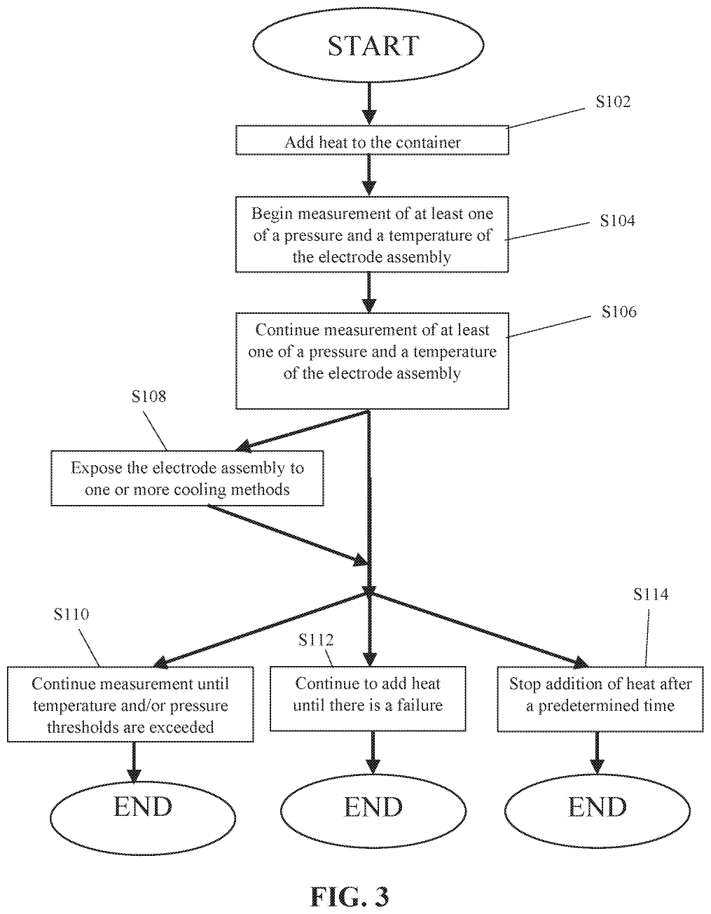

A method of performing a test with the electrode assembly 10 (battery test assembly) in which the aforementioned components are included is described in reference to FIG. 3. In order to test the electrode assembly 10, heat is added to the container 22 (S102). This heat is added by providing the heater 34 with electricity and/or by heating the external surface of the container 22, which simulates an elevated room temperature and/or an elevated operating environment temperature. The amount of electricity provided to the heater 34 and/or the amount of heat applied to the external surface of the container 22 can be regulated by a hardware controller.

As used herein, the term controller refers to the logical hardware (such as a single IC, or arrangement of custom ICs, ASICs, processors, microprocessors, controllers, FPGAs, adaptive computing ICs, or some other grouping of integrated circuits or electronic components which perform the functions discussed herein, with any associated memory, such as microprocessor memory or additional RAM, DRAM, SDRAM, SRAM, MRAM, ROM, PROM, FLASH, EPROM, or E²PROM) and/or software for controlling and delivering electricity and/or signals, as well as collect various data of the methodology of the disclosure. The controller or processor, with its associated memory, may be adapted or configured (via programming, FPGA interconnection, or hard-wiring) to perform the methodology of the disclosure, as discussed above and below. For example, the methodology may be programmed and stored, in a controller and other equivalent components, as a set of program instructions or other code (or equivalent configuration or other program) for subsequent execution when the controller or processor is operative. The various components of the controller may be provided together in a single controller unit in some cases, while in other cases one or more controller components may be provided separately from the others, sometimes in a different piece of hardware.

Upon adding heat to the container 22, measurement of at least one of a pressure and a temperature of the electrode assembly 10 can begin to be performed (S104). In one embodiment, at least one of the thermocouple 32 and the pressure sensor 30 can be used. The thermocouple(s) 32 is configured to transmit temperature data at the location of the thermocouple(s) 32 within the container 22. The pressure sensor 30 is configured to transmit pressure data at the location of the pressure sensor 30 within the container 22. The temperature and/or pressure data can be transmitted at specific time intervals and/or specific temperature and/or pressure thresholds. The transmitted temperature and/or pressure data can then be recorded.

As the measurement of at least one of a pressure and a temperature of the electrode assembly 10 continues to be performed (S106) the heat can be added to the container 22 for a specific amount of time, or heat can be added until a failure, such as a thermal runaway event. Also, this heat can be added at one level for the duration of the test, or it can be increased or decreased according to any suitable schedule.

An optional step includes (S108) exposing the electrode assembly 10 to one or more cooling methods, such as a sidewall cooling method (at least one of a submersion cooling and a flow cooling), and a cooling through the ends (such as cooling an end of the electrode assembly 10 with a cold plate). During this optional step (S108) the temperature at the location of the thermocouple 32 and the pressure within the electrode assembly 10 with the pressure sensor can both be measured and recorded.

Upon completion of S108 (or if S108 is not included, upon completion of S106), the method continues to one of S110, S112 or S114.

Under step S110 continues the measurement and compares measured values to a temperature threshold and/or a pressure threshold. If measured levels of the temperature and/or pressure exceed the temperature threshold and/or pressure threshold, the controller can cause the addition of heat to the container 22 to decrease, or stop. The method then ends.

Under step 112, the controller can continue to add heat to the container 22, even if the measured levels of the temperature and/or pressure exceed the temperature threshold and/or pressure threshold until there is a failure, such as a thermal runaway event, or the container 22 and/or cap 24 are separated and/or breached. The method then ends.

Under step 114, after a predetermined time, the controller causes the addition of heat to the container 22 to stop. The method then ends.

The described embodiments and examples of the present disclosure are intended to be illustrative rather than restrictive, and are not intended to represent every embodiment or example of the present disclosure. While the fundamental novel features of the disclosure as applied to various specific embodiments thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiment of the disclosure may be incorporated in any other disclosed or described or suggested form or embodiment as a general matter of design choice. Further, various modifications and variations can be made without departing from the spirit or scope of the disclosure as set forth in the following claims both literally and in equivalents recognized in law.

What is claimed is:

1. A battery test assembly comprising:
a container forming an enclosed cavity having sides, a top and a bottom with an opening in the top;
a first electrode having a first non-electrically active coating material;
a second electrode having a second non-electrically active coating material;
a separator disposed between the first electrode and the second electrode the separator comprising an insulator material; and
a non-ionic liquid within the cavity,
wherein the first electrode, separator and second electrode are wound in a spiral configuration within the container.

2. The battery test assembly of claim 1, further comprising a pressure sensor.

3. The battery test assembly of claim 2, wherein the pressure sensor is located between the first electrode and the container.

4. The battery test assembly of claim 1, further comprising at least one thermocouple within the cavity.

5. The battery test assembly of claim 4, wherein the thermocouple is located within a center of the spiral configuration.

6. The battery test assembly of claim 4, wherein the at least one thermocouple is between the first electrode and the second electrode.

7. The battery test assembly of claim 4, wherein the first electrode comprises a first electrode first surface and a first electrode second surface, the first electrode second surface opposite the first electrode first surface, and wherein the at least one thermocouple is between the first electrode first surface and the container.

8. The battery test assembly of claim 1, wherein the non-ionic liquid does not include a salt.

9. The battery test assembly of claim 1, wherein the non-ionic liquid comprises at least one of alcohol, propylene carbonate, dimethyl carbonate, ethylene carbonate, diethyl carbonate, and ethyl methyl carbonate.

10. The battery test assembly of claim 1, wherein the liquid comprises at least one of a boiling point and a vapor pressure that is within a range of about 5% to 30% of a boiling point and a vapor pressure of LiPF₆.

11. The battery test assembly of claim 1, further comprising at least one heater.

12. The battery test assembly of claim 11, wherein the at least one heater comprises a resistive insertion heater and a resistive sheet heater.

13. The battery test assembly of claim 12, wherein the resistive insertion heater is located at a center of the spiral configuration.

14. The battery test assembly of claim 13, wherein the resistive sheet heater is between the first electrode and the separator, between the second electrode and the separator, or between both the first electrode and the separator and the second electrode and the separator.

15. The battery test assembly of claim 1, wherein the first electrode comprises a first electrode first surface and a first electrode second surface, the first electrode second surface opposite the first electrode first surface, and wherein both the first electrode first surface and the first electrode second surface are coated with a first non-electrically active coating material.

16. The battery test assembly of claim 1, wherein the second electrode comprises a second electrode first surface and a second electrode second surface, the second electrode second surface opposite the second electrode first surface, and wherein both the second electrode first surface and the second electrode second surface are coated with a second non-electrically active coating material.

17. A method of performing a test with a battery test assembly, the method comprising:
applying energy to the battery test assembly, wherein the energy is at least one of an electrical energy and a heat energy applied to an external surface of the battery test assembly, the battery test assembly comprising:
a container forming an enclosed cavity with an opening;
a first electrode having a first non-electrically active coating material;
a second electrode having a second non-electrically active coating material;
a separator disposed between the first electrode and the second electrode the separator comprising an insulator material; and
a non-ionic liquid within the cavity,
wherein the first electrode, separator and second electrode are wound in a spiral configuration within the container; and
measuring at least one of a pressure and a temperature within the battery test assembly.

18. The method of claim 17, wherein the battery test assembly further comprises at least one heater configured to receive the electrical energy, at least one thermocouple, and at least one pressure sensor.

19. The method of claim 18, wherein the at least one thermocouple measures the temperature within the battery test assembly.

20. The method of claim 18, wherein the at least one pressure sensor measures the pressure within the battery test assembly.

21. The method of claim 17, wherein the method further comprises exposing the battery test assembly to a sidewall cooling, a cooling through ends of the battery test assembly, and combinations thereof.
